(19) United States
(12) Patent Application Publication
(10) Pub. No.: US 2026/0030624 A1
(43) Pub. Date: Jan. 29, 2026

(54) SYSTEM FOR THE PAYMENT OF COMMERCIAL TRANSACTIONS

(71) Applicant: Oleg Nikolaevich TITOV, Novosibirsk (RU)

(72) Inventor: Oleg Nikolaevich TITOV, Novosibirsk (RU)

(21) Appl. No.: 18/997,716

(22) PCT Filed: Oct. 12, 2023
(86) PCT No.: PCT/RU2023/050237

§ 371 Date: Jan. 22, 2025

(30) Foreign Application Priority Data
Feb. 17, 2023 (RU) 2023103657

(51) Int. Cl. G06Q 20/38

(52) U.S. Cl. CPC G06Q 20/389; G06Q 2220/00

(57) ABSTRACT

The invention relates to systems for organizing and monitoring payments for trade operations. This system for the payment of commercial transactions includes a block for interaction with system users; a block for issuing and/or registering electronic documents (EDs) that confirm the financial obligations of the user designated in an ED to pay to the ED owner the designated amount of money in the designated currency; a block for creating, signing, encrypting, and storing smart contracts; a block for forming a closed chain of smart contracts for the purchase and sale of EDs, including at least one smart contract for the ED purchase and one smart contract for the ED sale in a currency different from the payment currency for the other smart contracts generated by the block for creating, signing, encrypting, and storing smart contracts. The technical result is manifested in increased efficiency, security and control over the implementation of payments for trade transactions.

### TECHNICAL FIELD

The technical solution relates to blockchain technologies and information processing, specifically to systems for organizing and controlling payments for trade operations, namely for implementing cross-border payments.

### PRIOR ART

Prior art includes systems for organizing payments for imported goods.

A known financial services system for supply chains based on blockchain includes an information management platform for supply chains used to manage information about customers, orders, receipt and delivery of goods, initial payments, and contracts; a consortium chain software module used to ensure data access, data security, and data privacy in the supply chain; a blockchain data proof storage module for storing evidence of security and providing business data; and a credit extension management platform for managing the full financing lifecycle and managing financing limits for the supplier and the factoring company. Patent application No. CN111626733, published on Sep. 4, 2020.

Another known system is a blockchain-based credit certificate verification data processing system, which includes a data request reception module for verifying the user's letter of credit; a verification module to check the data request against a pre-deployed credit smart contract for generating credit verification transaction data; and a letter of credit status management module based on the verification transaction data. The system also includes a blockchain contract deployment module for executing structured data processing according to transaction description information and pre-set letter of credit status information for deploying the letter of credit smart contract. Patent application No. CN113159932, published on Jul. 23, 2021.

The main disadvantages of the known systems are their inconvenience, low efficiency in conducting trade operations, high labor intensity, significant time costs for gathering, processing, and providing information, low reliability of system operations, and limitations in their functional capabilities.

### DISCLOSURE OF INVENTION

The objective of the claimed solution is to create a technological and efficient system for the payment of commercial transactions, allowing for the payment for goods or services between users.

The technical result of the claimed technical solutions is the simplification of the implementation of payments for trade operations.

The simplification of the implementation of payments for trade operations is achieved by reducing the steps required to carry out trade operations and significantly shortening the time needed to conduct trade transactions.

The technical result of the claimed technical solutions also includes increased security for cross-border payment transactions and valuable documents, as well as enhanced control over trade operations.

The technical results of the claimed technical solutions also include increased efficiency in conducting trade operations.

These technical results are achieved by the configuration of the system for the payment of commercial transactions that includes at least one user interaction block for registering and storing user identification data, identifying users, and receiving and processing user requests; a block for issuing and/or registering electronic documents (EDs) that confirm certain financial obligations of the user who issues the ED or is designated in the ED to pay to the owner of the ED, under the conditions specified in the ED, the amount of money specified in the ED in the currency specified in the ED, or its equivalent, wherein the issuance block being capable of encrypting and storing information about EDs; a block for creating, signing, encrypting, and storing smart contracts, including smart contracts for issuing EDs, smart contracts for purchasing EDs, smart contracts for selling EDs, and smart contracts for purchasing and selling EDs, wherein each smart contract has an identification number for accounting and identifying smart contracts by the system and wherein the encrypted data of smart contracts is distributed and stored across multiple electronic storage facilities combined into a single network; a block for forming a closed chain of smart contracts for the purchase and sale of EDs from corresponding smart contracts for purchasing EDs and smart contracts for selling EDs among at least three users, including at least one smart contract for purchasing EDs and one smart contract for selling EDs in a currency different from the currency of payment for the other smart contracts, wherein the abovementioned block is connected to the block for creating, signing, encrypting, and storing smart contracts.

The claimed system includes a block for issuing and/or registering electronic documents (EDs) that stipulate and confirm certain financial obligations of the user who issues the ED or is designated in the ED to pay to the owner of the ED, under the conditions specified in the ED, the amount of money in the currency specified in the ED or its equivalent indicated in the ED, wherein the issuance block being capable of encrypting and storing information about EDs.

The main advantage of the electronic document (ED), corresponding to the above stated description, over a promissory note or obligation under a contract is the increased functionality, acceleration, and simplification of financial transactions between users of the system. In contractual relationships, under ordinary conditions, the payer and the recipient of funds are clearly defined. If a supplier, for example, wants a buyer to settle with another partner (the supplier's creditor), it is necessary first to agree on this interaction with the buyer and conclude a debt transfer agreement. The simultaneous use of smart contracts and EDs, according to the claimed solution, significantly simplifies such actions: if the buyer issues (sells) their ED, as a guarantee of payment, to the supplier, the supplier can at any time transfer (sell) this valuable document to anyone, including paying off his debts through the ED, so that the right to claim under the ED will be received by the new owner. There can be an unlimited number of transactions for the transfer of electronic documents within a closed chain of smart contracts, and, therefore, many counterparty users can repay debts to each other without actual payment in cash.

This system makes it possible to achieve that payment in cash will not be made even once or will be made only once-when the user who initially submitted an application for the issue of an ED or the registration of an ED settles with its last owner who closes the chain. The use of EDs makes it possible to simplify cross-border payments for goods or services, transfer of funds abroad and purchase/sale of foreign currency. In addition, this solution, which consists in paying for trade transactions through EDs, ensures the security of transactions due to the possibility of complete control over the movement of EDs, recording of the data of all owners, and the impossibility of falsifying EDs. Moreover, the application of this solution, in cases when the user who initially submitted an application for the issue of an electronic document or for the registration of an electronic document pays in cash to the last owner of the electronic document, thus closing the chain of ED owners, allows, with a high probability, to eliminate the need for bank compliance control that significantly increases the convenience and speed of trade transactions, including cross-border ones.

The declared system also includes a block for creating, signing, encrypting, and storing smart contracts, including smart contracts for issuing EDs, smart contracts for purchasing EDs, smart contracts for selling EDs, and smart contracts for purchasing and selling of EDs, wherein each smart contract has an identification number for accounting and identifying smart contracts by the system and wherein the encrypted data of smart contracts is distributed and stored across multiple electronic storage facilities combined into a single network.

The presence of these types of smart contracts is a minimal and sufficient condition to carry out transactions for the transfer of electronic documents under specific, individual conditions for each user, specified by the users themselves in their smart contracts.

Initially, smart contracts for the emission of EDs, smart contracts for the purchase of EDs, smart contracts for the sale of EDs are signed, on their own or a trusted platform, between users of the system and the legal entity that owns and/or manages the system. Then each smart contract controls the terms of the contract and, if the conditions are met, automatically fulfills its obligations. The result of the execution of smart contracts for the purchase of EDs and smart contracts for the sale of EDs is a closed chain of smart contracts for the purchase and sale of EDs.

Another important difference of the claimed system is the presence of a block for forming a closed chain of smart contracts for the purchase and sale of EDs from corresponding (logically connecting, according to coinciding conditions) smart contracts for the purchase of EDs and smart contracts for the sale of EDs between at least three users, including: at least one smart contract for the ED purchase and one smart contract for the ED sale in a currency different from the payment currency for other smart contracts included in this chain, associated with the block for creating, signing, encrypting and storing smart contracts.

This block makes it possible to automatically carry out cross-border trading operations without actually transferring funds abroad in compliance with all the conditions specified in the smart contracts collected in a closed chain, since the formation of a closed chain is based on searching for matches of the conditions and requirements specified in smart contracts of the users interested in performing a trading operation.

The block for forming a closed chain of smart contracts also reduces the time for implementing a trading operation and ensures automatic selection of users who can become participants in trading relations on conditions acceptable to all. According to the stated solution, the obligation to transfer funds arises only after the formation of a completely closed chain of smart contracts for the purchase and sale of EDs between the participants of the chain. The advantage of this solution also lies in significantly reducing or eliminating the risk of non-fulfillment of one of the conditions specified in smart contracts of users and in maintaining financial balance.

The user interaction module serves as a link between the system and each specific registered user. The user interaction module enables user registration in the system, storage of ED and user identification data, user identification, reception and processing of user requests, searching for buyers and sellers of EDs, and executing various transactions and other legal actions with EDs on behalf of users, including but not limited to the sale of EDs, their transfer, acceptance, discounting, fractionalization, liability insurance for EDs, and organizing and informing both regular and potential users of the system.

In preferred embodiments, the system for the payment of commercial transactions also includes a module for assigning and monitoring the status of system users and/or EDs acquired and/or issued by users of the system, and/or a module for assigning and monitoring the status of smart contracts. The presence of these modules further enhances the security of transactions by providing additional information regarding the reliability of users and of their EDs and the confirmation of smart contracts.

The module for creating, signing, encrypting, and storing smart contracts can also be designed to allow for the creation, signing, encryption, and storage of smart contracts for the purchase of goods or services by a user and for the sale of goods or services by a user in instances when participating users do not have active contracts for the supply/acquisition of goods or services, as well as for creating, signing, encrypting, and storing smart contracts for the division of EDs, smart contracts for the combination of EDs, or smart contracts for the exchange of EDs acquired and/or issued by users of the system.

The described system blocks can be implemented as a single block possessing the described characteristics and capable of performing the listed functions, or as interconnected modules within the system.

It is preferable for the system for the payment of commercial transactions to take the form of a digital platform to automate trading operations, ensure increased control and security of their realization, provide remote access for all system users and user interaction blocks, and to enable the use of unified algorithms for the formation of smart contract chains. Such an embodiment significantly simplifies requests of system users, trading relationships among system users, and the interaction of the system with its users.

### BRIEF DESCRIPTION OF DRAWINGS

The claimed technical solution is further illustrated by the figure, which conditionally represents one of the possible embodiments of the system for the payment of commercial transactions.

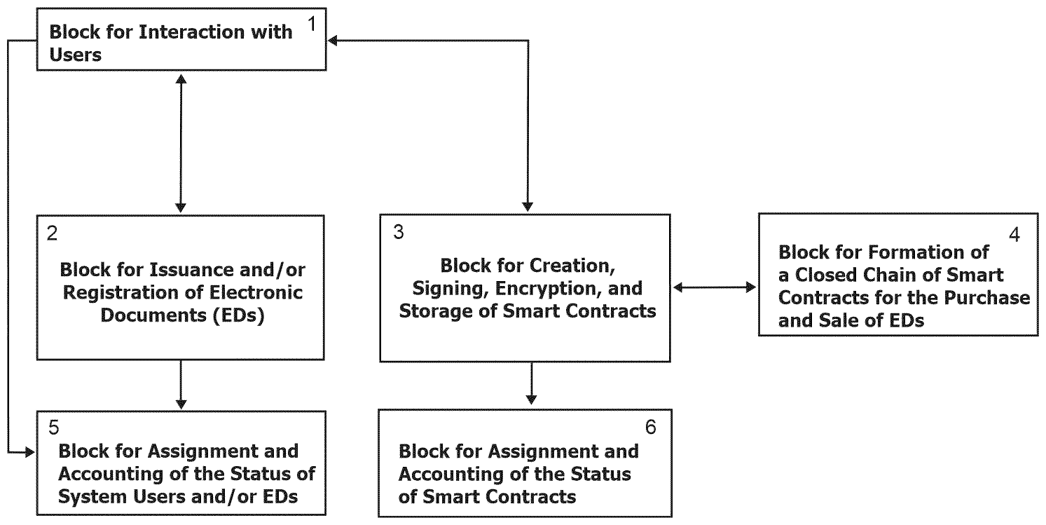

FIG. 1 presents a functional diagram reflecting the structure of a preferred embodiment of the system for the payment of commercial transactions, with the following elements marked by numbers:
Block (1) for Interaction with Users;
Block (2) for Issuance and/or Registration of Electronic Documents (EDs);
Block (3) for Creation, Signing, Encryption, and Storage of Smart Contracts;
Block (4) for Formation of a Closed Chain of Smart Contracts for the Purchase and Sale of EDs;
Block (5) for Assignment and Accounting of the Status of System Users and/or EDs;
Block (6) for Assignment and Accounting of the Status of Smart Contracts.

### EMBODIMENTS OF INVENTION

The structure of the system for the payment of commercial transactions is described below, with references to the drawing.

The system for the payment of commercial transactions includes at least one user interaction module (1) within the system.

Preferably, the user interaction block (1) serves as a service center for users to execute trading operations, including a user module for users to access the declared system and to be notified about their related trading operations. To implement this block, a computer with input and output information modules connected to the system is sufficient. A preferable embodiment of the user interaction block (1) includes and/or interacts with a database, a participant registration module, a data storage module, an account management module, a payment document generation module, an outgoing registry formation module, an incoming registry processing module, etc.

Potential users of the system may include various companies, commercial banks, stock exchanges, and other organizations and individuals interested in relevant trading operations, willing to transfer or acquire goods, services, or monetary funds exclusively through EDs. In specific cases, an additional module of the system itself (a legal entity or a physical person) associated with the interaction module (1) may serve as a user of the system. A legal entity that owns and/or manages the system, like other users of the system, can issue its EDs and buy and sell EDs. A user may be a company managing the platform, its operator, who can act, both in their own name and on behalf of other platform users, fur purpose such as, but not limited to, searching for sellers or buyers of EDs. A preferable embodiment of the system also includes an administrator module, which is a user of the platform with access to configuring the platform and user settings.

The system for the payment of commercial transactions includes a block (2) for issuing and/or registering EDs that stipulate and confirm certain financial obligations of the user who issues the ED or is designated in the ED to pay to the owner of the ED, under the conditions specified in the ED, the amount of money indicated in the ED in the currency specified in the ED, or its equivalent indicated in the ED. The ED issuance/registration block (2) is capable of encrypting and storing information about the issued or registered EDs. Any type of bill of exchange, including a crypto note, a token, a non-fungible token (NFT), or any other document that meets the specified function, including those that assume payment in cryptocurrency, such as, but not limited to, altcoins and, specifically, stablecoins, may be used as EDs.

The declared system also includes a block (3) for creating, signing, encrypting, and storing smart contracts, which includes a module for creating, signing, encrypting, and storing smart contracts for the issuance of EDs, a module for creating, signing, encrypting, and storing smart contracts for the purchase of EDs, a module for creating, signing, encrypting, and storing smart contracts for the sale of EDs, and a module for creating, signing, encrypting, and storing smart contracts for the purchase and sale of EDs. Each smart contract has an identification number for accounting and identification by the system.

According to the claimed technical solution, the system for the payment of commercial transactions includes a block (4)—linked to the block (3) for creating, signing, encrypting, and storing smart contracts—for forming a closed chain of smart contracts for the purchase and sale of EDs, consisting of the relevant smart contracts for purchasing EDs and smart contracts for selling EDs between at least three users and including at least one smart contract for ED purchasing and one smart contract for ED selling in a currency different from the currency of payment for the other smart contracts.

Preferably, the system for the payment of commercial transactions includes a block (5) for assigning and accounting for the status of system users and/or EDs acquired and/or issued by system users. The statuses may reflect various information about a specific ED or a specific user. Preferably, block (3) for creating, signing, encrypting, and storing smart contracts, in any of its described embodiments, includes a module for creating, signing, encrypting, and storing a smart contract for the purchase of goods or services by a system user and a module for creating, signing, encrypting, and storing a smart contract for the sale of goods or services by a system user.

The system for the payment of commercial transactions, in any of the described embodiments, may include a block (6) for assigning of and accounting for the status of smart contracts. The statuses of smart contracts may include information about their confirmation or lack of thereof.

Block (3) for creating, signing, encrypting, and storing smart contracts may additionally include a module for creating, signing, encrypting, and storing smart contracts for the division of EDs, or smart contracts for the combination of EDs, or smart contracts for the exchange of EDs acquired and/or issued by system users.

Examples of implementation of payments for trade transactions are presented below.

In the process of operation, the system registers new clients-users of the system, receives from its client-users various requests for the issue and/or registration of electronic documents, for the acquisition and/or sale of electronic documents, as well as for the purchase and/or sale of goods and/or services.

### Example 1

In the block (1), for interaction with users, three new users of the system are registered.

In the block (5), for assigning and recording the status of system users and/or electronic documents acquired and/or issued by system users, the status is assigned to the system users.

In the block (3), for creating, signing, encrypting, and storing smart contracts, registration of a smart contract for the issue of an ED, a smart contract for the sale of an ED and a smart contract for the purchase of an ED is executed between the platform that manages the system and the first user of the system; the second of the system users registers a smart contract for the sale of an ED and a smart contract for the purchase of an ED; the third of the system users registers a smart contract for the sale of an ED and a smart contract for the purchase of an ED.

Providing that at least one of the users wants to sell an ED and one of the users wants to buy an ED in a currency different from the payment currency for the other smart contracts.

In this case, the block (2), for issuing EDs and/or registering EDs, carries out the issue and/or registration of emission of an ED by the first user.

In the block (4), for forming a chain of smart contracts for the purchase of EDs and smart contracts for the sale of EDs into a closed chain of smart contracts for the purchase and sale of EDs, a logical formation of a closed chain is carried out from the registered smart contracts for the purchase of EDs and the registered smart contracts for the sale of EDs, with matching conditions.

In this case, the block (3), for creating, signing, encrypting, and storing smart contracts, carries out the formation and registration of a smart ED purchase and sale contract between the first ED seller (who is also the first user of the system, also the ED issuer) and the first ED buyer (the second user of the system), the formation and registration of a smart contract for the ED purchase and sale between the first ED buyer (the second user of the system) and the second ED buyer (the third user of the system), formation and registration of a smart contract for the ED purchase and sale between the second ED buyer (the third user of the system) and the first ED seller (the first user of the system/ED issuer). Providing that at least one of the system users sells an ED and one of the system users buys an ED in a currency different from the payment currency for the other smart contracts.

In this case, the block (6), for assigning and accounting for the status of smart contracts, assigns the status “executed” to the three smart contracts for the ED sale and the three smart contracts for the ED purchase.

At the same time, the block (1), for interaction with users, notifies the system users who are involved in this chain about the execution of all the smart contracts for the ED sale, the execution of all the smart contracts for the ED purchase, the formation and registration of a smart contract for the ED purchase and sale between the first ED seller (also the first user of the system, also the ED issuer) and the first ED buyer (the second user of the system), the formation and registration of a smart contract for the ED purchase and sale between the first ED buyer (the second user of the system) and the second ED buyer (the third user of the system), and the formation and registration of a smart contract for the ED purchase and sale between the second ED buyer (the third user of the system) and the first ED seller (the first user of the system/ED issuer).

### Example 2

Implementation of trade transactions between more than three users from two or more countries.

In the block (3), for creating, signing, encrypting and storing smart contracts, a smart contract for the emission of electronic documents, a smart contract for the ED sale and a smart contract for the ED purchase is registered between the platform that manages the system and the first user of the system (the first user involved into this chain); a smart contract for the ED sale and a smart contract for the ED purchase is registered between the platform that manages the system and the second user of the system (the second user involved into this chain); a smart contract for the ED sale and a smart contract for the ED purchase is registered between the platform that manages the system and the third user of the system (the third user involved into this chain); a smart contract for the ED sale and a smart contract for the ED purchase is registered between the platform that manages the system and the N1 user of the system (the N1 user involved into this chain); a smart contract for the ED sale and a smart contract for the ED purchase is registered between the platform that manages the system and the N user of the system (the N user involved into this chain).

Providing that at least one of the users wants to sell an ED and one of the users wants to buy an ED in a currency different from the payment currency for the other smart contracts.

In this case, the block (2), for issuing EDs and/or registering EDs, carries out the issue and/or registration of the emission of an ED by one of the users (the first user involved into this chain).

In the block (4), for forming a chain from smart contracts for the purchase of EDs and smart contracts for the sale of EDs into a closed chain from smart contracts for the purchase and sale of EDs, a logical formation of a closed chain is carried out from the registered smart contracts for the ED purchase and the registered smart contracts for the ED sale, with matching conditions.

In this case, the block (3), for creating, signing, encrypting and storing smart contracts, carries out the formation and registration of a smart contract for the ED purchase and sale between the first ED seller (the first user involved into this chain and the ED issuer) and the first ED buyer (the second user involved into this chain), the formation and registration of a smart contract for the ED purchase and sale between the first ED buyer (the second user involved into this chain) and the second ED buyer (the third user involved into this chain), the formation and registration of a smart contract for the ED purchase and sale between the N2 ED buyer (the N1 user involved into this chain), and the N1 ED buyer (N user involved into this chain), the formation and registration of a smart contract for the ED purchase and sale between the N1 ED buyer (the N user involved into this chain), and the first ED seller (the first user involved into this chain and the ED issuer).

In this case, the block (6), for assigning and accounting for the status of smart contracts, assigns the status “executed” to all the smart contracts for the ED sale and all the smart contracts for the ED purchase, each of which serves as a link in the formed closed chain of smart contracts for the ED purchase and sale.

In this case, the block (1), for interaction with users, notifies the system users who are involved in this chain about the execution of all the smart contracts for the sale of EDs that are included in this chain, the execution of all the smart contracts for the purchase of EDs that are included in this chain, the formation and registration of a smart contract for the ED purchase and sale between the first ED seller (the first user involved into this chain and the ED issuer) and the first ED buyer (the second user involved into this chain), the formation and registration of a smart contract for the ED purchase and sale between the first ED buyer (the second user involved into this chain) and the second ED buyer (the third user involved into this chain), the formation and registration of a smart contract for the ED purchase and sale between the N2 buyer (the N1 user involved into this chain) and the N1 ED buyer (the N user involved into this chain), the formation and registration of a smart contract for the ED purchase and sale between the N1 buyer (the N user involved into this chain) and the first ED seller (the first user involved into this chain and the ED issuer).

### INDUSTRIAL APPLICABILITY

The claimed system for implementing trade transactions can be used between an unlimited number of users and of blocks (1) of interaction from an unlimited number of countries to carry out various trade transactions, including deferred payment transactions, and to implement export-import contracts and crowdfunding projects.

The system allows residents of different countries to carry out trading operations without compliance control over the transfer of funds and the stage of currency conversion, as well as conversion of currencies without the stage of transferring funds through banking systems.

The presented figures, the description of the system structure and the examples of its use do not exhaust possible implementation options and do not in any way limit the scope of the proposed technical solution. Other embodiments are possible within the scope of the claims.

1. A system for the payment of commercial transactions comprising:
at least one user interaction block for registering and storing user identification data, identifying users, and receiving and processing user requests;
a block for issuing and/or registering electronic documents (EDs) that confirm certain financial obligations of the user who issues the ED or is designated in the ED to pay to the owner of the ED, under the conditions specified in the ED, the amount of money specified in the ED in the currency specified in the ED, or its equivalent, wherein the issuance block being capable of encrypting and storing information about EDs;
a block for creating, signing, encrypting, and storing smart contracts, including smart contracts for issuing EDs, smart contracts for purchasing EDs, smart contracts for selling EDs, and smart contracts for purchasing and selling EDs, wherein each smart contract has an identification number for accounting and identifying smart contracts by the system and wherein the encrypted data of smart contracts is distributed and stored across multiple electronic storage facilities combined into a single network;
a block for forming a closed chain of smart contracts for the purchase and sale of EDs from corresponding smart contracts for purchasing EDs and smart contracts for selling EDs among at least three users, including at least one smart contract for purchasing EDs and one smart contract for selling EDs in a currency different from the currency of payment for the other smart contracts, wherein the abovementioned block is connected to the block for creating, signing, encrypting, and storing smart contracts.

2. The system for the payment of commercial transactions, according to claim 1, wherein it includes a block for assigning and recording the status of users and/or electronic documents acquired and/or issued by users.

3. The system for the payment of commercial transactions according to claim 1, wherein the block for creating, signing, encrypting, and storing smart contracts is designed to create, sign, encrypt, and store smart contracts for purchasing goods or services by a user of the system and smart contracts for selling goods or services by a user of the system.

4. The system for the payment of commercial transactions according to claim 1, wherein it includes a block for assigning of and accounting for the status of smart contracts.

5. The system for the payment of commercial transactions according to claim 1, wherein the block for creating, signing, encrypting, and storing smart contracts is designed to create, sign, encrypt, and store smart contracts for dividing EDs and/or smart contracts for combining EDs and/or smart contracts for the exchange of EDs purchased and/or issued by users of the system.
